(19) United States
(12) Patent Application Publication
(10) Pub. No.: US 2006/0093994 A1
(43) Pub. Date: May 4, 2006

(54) Modular material design system and method

(76) Inventor: William K. Grant, Canton, GA (US)

Correspondence Address: GARDNER GROFF SANTOS & GREENWALD, P.C., 2018 POWERS FERRY ROAD, SUITE 800, ATLANTA, GA, 30339, US

(21) Appl. No.: 11/299,713

(22) Filed: Dec. 12, 2005

Related U.S. Application Data
(62) Division of application No. 10/417,661, filed on Apr. 17, 2003.
(60) Provisional application No. 60/373,436, filed on Apr. 17, 2002.
(60) Provisional application No. 60/424,459, filed on Nov. 7, 2002.

(51) Int. Cl. G09B 19/00

(52) U.S. Cl. 434/98

(57) ABSTRACT

Modular surface treatment materials such as carpet tiles, ceramic floor and wall panels and tiles, ceiling tiles, vinyl flooring squares, wall covering materials, and the like, are provided in a matrix of a plurality of different colors and a sequential array of tonal variations within each color. A system and method, including a computer-aided design tool for laying out patterns of individual modular material units selected from the color-tone matrix, is included, as well as display devices for materials in the matrix.

### CROSS-REFERENCE TO RELATED APPLICATIONS

This application claims the benefit of U.S. Provisional Patent Application Ser. No. 60/373,436, filed Apr. 17, 2002, and U.S. Provisional Patent Application Ser. No. 60/424,459, filed Nov. 7, 2002, which applications are incorporated herein by reference in their entireties for all purposes.

### TECHNICAL FIELD

The present invention relates generally to the field of decorating and design, and more particularly to a design system and associated methods for application of modular surface treatment materials selected from a matrix of colors and tonal variations within each color.

### BACKGROUND OF THE INVENTION

A variety of modular surface treatment materials are used in the design and decorating field. For example, carpet tiles, ceramic floor tiles and vinyl flooring squares are applied to a floor surface to improve its appearance and/or performance. Wall panels and wall tiles are applied to wall surfaces, or to form a wall. Ceiling tiles and panels are applied to ceilings or used to create a ceiling. Modular materials can be fabricated in square, rectangular, triangular, or otherwise-shaped individual units, configured to interengage or abut one or more like or cooperating units to form a composite, multi-unit surface or covering. For example, a plurality of individual units of square modular carpet tile may be installed side-by-side and/or end-to-end, to cover all or a portion of a floor or other surface.

In most instances, an entire floor or other surface is covered with modular units of the same color and/or pattern. In other instances, a basic “checkerboard” pattern may be created by alternating modular units of contrasting colors. To date, however, modular surface treatment materials have been provided in a limited number of standard colors. And known modular surface treatment materials have not enabled design using a sequential array of tonal variations within one or more colors. In addition, there have been few, if any, efforts to enable computer-assisted creative decorative design using known modular surface treatment materials, and display and design tools for known modular surface treatment materials are not well suited to use with materials in a matrix of color and tonal variations.

Accordingly, it has been recognized that sophisticated design using modular surface treatment materials has not yet been optimized to reach its full decorative potential. It is to the provision of a system and method for improved design and decorating using modular surface treatment materials that the present invention is primarily directed.

### SUMMARY OF THE INVENTION

The present invention provides a system and method for improved design and decorating using modular surface treatment materials. By providing modular surface treatment materials, including without limitation carpet tiles, ceramic floor tiles, vinyl flooring squares, wall panels, wall tiles and/or ceiling tiles, in a matrix of different colors and sequentially varied tonal intensities within each different color, the present invention dramatically increases available design and decorating options. The present invention also enables more efficient and creative design using modular surface treatment materials, by providing computer-assisted design tools and improved display devices for marketing and design programs.

In one aspect, the present invention is a matrix of modular surface treatment materials. The matrix of the present invention preferably includes modular surface treatment units having a first color and a sequential array of tonal variations within that first color. The matrix of the present invention preferably also includes modular surface treatment units having a second color, different from the first color, and a sequential array of tonal variations within that second color. Third and additional colors are optionally included in the matrix, with tonal variations of each color.

In another aspect, the invention is a method of design using modular surface treatment materials. The method preferably includes defining a matrix having a plurality of different colors and a plurality of different tonal intensities within each different color. The method preferably also includes providing modular surface treatment units in each of the plurality of different colors and intensities. The method preferably further comprises specifying one or more of the modular surface treatment units for application to define a surface.

In still another aspect, the invention is a surface comprising a plurality of modular surface treatment units. The modular surface treatment units preferably include units having a first color and at least two tonal variations of that first color. The modular surface treatment units preferably also include units having a second color and at least two tonal variations of that second color.

In another aspect, the invention is a computer assisted design system. The system preferably includes a computer having a display device and at least one input device for receiving input from a designer. The system preferably also includes a graphical user interface facilitating input via the at least one input device of data representing a decorated surface and modular surface treatment units selected for application to the decorated surface, wherein the selected modular surface treatment units comprise a plurality of different colors and a plurality of different tonal intensities within each different color.

In still another aspect, the invention is a modular surface treatment system including units of modular surface treatment material selected from a matrix, the matrix comprising units of modular surface treatment material of a plurality of colors and of a plurality of tonal variations within each of the plurality of colors. In another aspect, the present invention is a unit of modular surface treatment material selected from the above-described matrix.

In another aspect, the invention is a method of decorating a surface. The method preferably includes selecting units of modular surface treatment material from a matrix of modular surface treatment material units, the matrix including a plurality of colors and a plurality of tonal variations within each of the colors. The selected units of modular surface treatment material are then preferably applied to a surface to be decorated, according to a specified pattern or design.

In yet another aspect, the invention is a computer-implemented system for carrying out the above-described method. In still another aspect, the invention is a computer software program for carrying out the above-described computer-implemented system. In another aspect, the invention is computer readable media, such as a recordable disk, programmable chip, or the like comprising the above-described software.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

FIG. 1 shows a matrix of colors and tonal values of modular surface treatment materials according to one example embodiment of the system and method of the present invention.

FIG. 2 shows a matrix of colors and tonal values of modular surface treatment materials according to another example embodiment of the system and method of the present invention.

FIG. 3 shows a modular floor-covering system according to an example embodiment of the present invention.

FIG. 4 shows a modular wall-covering system according to an example embodiment of the present invention.

FIG. 5 shows a user interface of a computer-implemented design tool according to an example embodiment of the present invention.

FIGS. 6 and 7 show sample display tools according to example embodiments of the present invention.

FIGS. 8-19 show modular designs according to example embodiments of the present invention.

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

One embodiment of the present invention is a modular surface treatment system comprising one or more, and most preferably a plurality of units of modular surface treatment material selected from a color/tone matrix. The modular surface treatment material units can take the form of, for example, carpet tiles of square, rectangular, triangular or other shape(s) and sizes, such as one-foot by one-foot self-adhesive carpet squares; floor tiles of vinyl, ceramic or other materials; ceiling tiles; wall-covering sheets or panels; rigid wall panels, or other units of material suitable for application to a surface, or to form a surface. Optionally, the units of modular surface treatment material have one or more designs or surface texture applied to one or more surfaces thereof, for enhancing the appearance and/or performance of the treated surface.

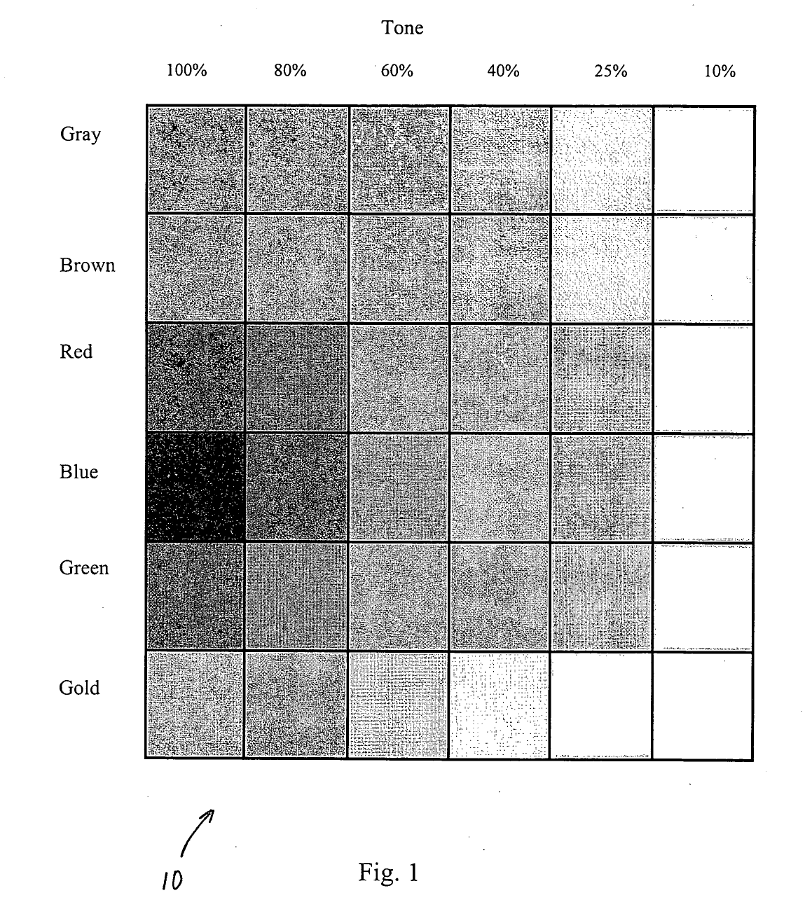

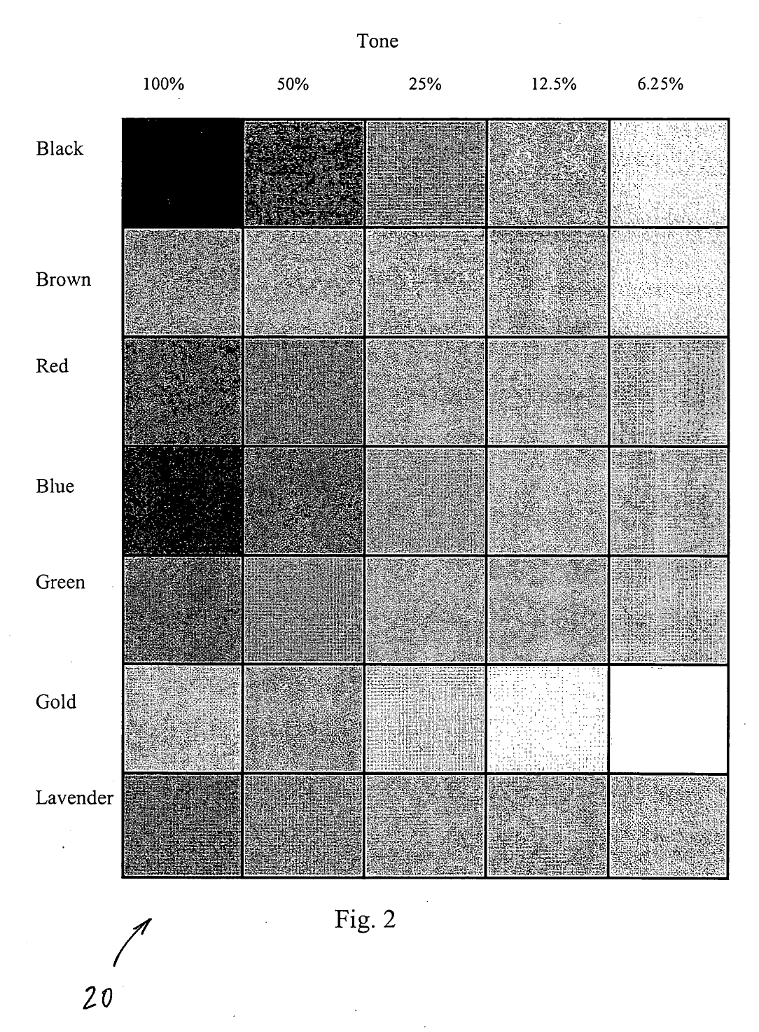

The matrix of modular surface materials of the present invention preferably includes units of modular surface treatment material of a plurality of colors and of a plurality of tonal variations within each of said plurality of colors (a “color family”). In preferred form, the matrix includes at least three color families. In particularly preferred embodiments, at least the primary colors red, blue and yellow; or alternatively red, blue and green, are included. Optionally, the matrix also includes the colors black, white and/or gray. In the example embodiment of FIG. 1, the matrix 10 includes six color families: gray, brown, red, blue, green, and gold. In the alternate embodiment of FIG. 2, the matrix 20 includes seven color families, namely black, brown, red, blue, green, gold, and lavender. In alternate embodiments, the matrix includes more, fewer, and/or different color families than are depicted in the embodiments of the drawing figures.

Within each color family, a number of tonal variations (lighter and darker shades, or higher and lower intensities of that color) are preferably provided. The tonal variations are preferably provided in a sequential array of tonal variations of each color. The sequential array can comprise a regular sequence wherein the intensity or shade of each successive element in the series of tonal variations is a fixed percentage of the intensity or shade of the immediately preceding element in the series, or an irregular sequence wherein successive elements have differing variation in intensity or shade relative to their preceding element. The sequence of tonal variation may be the same or different for each color family within the matrix. In particularly preferred embodiments of the invention, the tonal variations are substantially the same within each color family, and all of the colors and all of the tonal variations are selected to permit one or more material unit(s) of each color/tone to be used together with one or more material unit(s) of any other color/tone to generate an aesthetically pleasing design (i.e., no color/tone of the system clashes with any other color/tone of the system). For instance, each “parent” color (the 100% tonal value of each color family) is preferably selected to be compatible with each other parent color of the system; all of the derivative tonal variations within each color family are preferably based on the same color formula as the parent color of that color family; and there is preferably a consistent relationship or mathematical formula determining the tonal intensity of successive derivative tonal variations within each color family, which relationship or formula is preferably the same for all of the color families in the system. Because all of the parent colors are compatible with one another, and because all of the color families use the same formula of tonal intensities for each derivative tonal variation within the color family, different tonal variations are compatible within and across color families. Two particularly preferred arrays of tonal variation are depicted in the figures by way of example. FIG. 1 shows a matrix 10 wherein the second (80%), third (60%) and fourth (40%) tonal variations of each color have an intensity or shade of about twenty percent less than the immediately preceding element; and the fifth (25%) and sixth (10%) elements have an intensity or shade of about fifteen percent less than the immediately preceding element. FIG. 2 shows a matrix 20 wherein each successive element has a tonal intensity of about one-half that of the immediately preceding element (100%, 50%, 25%, 12.5%, and 6.25%).

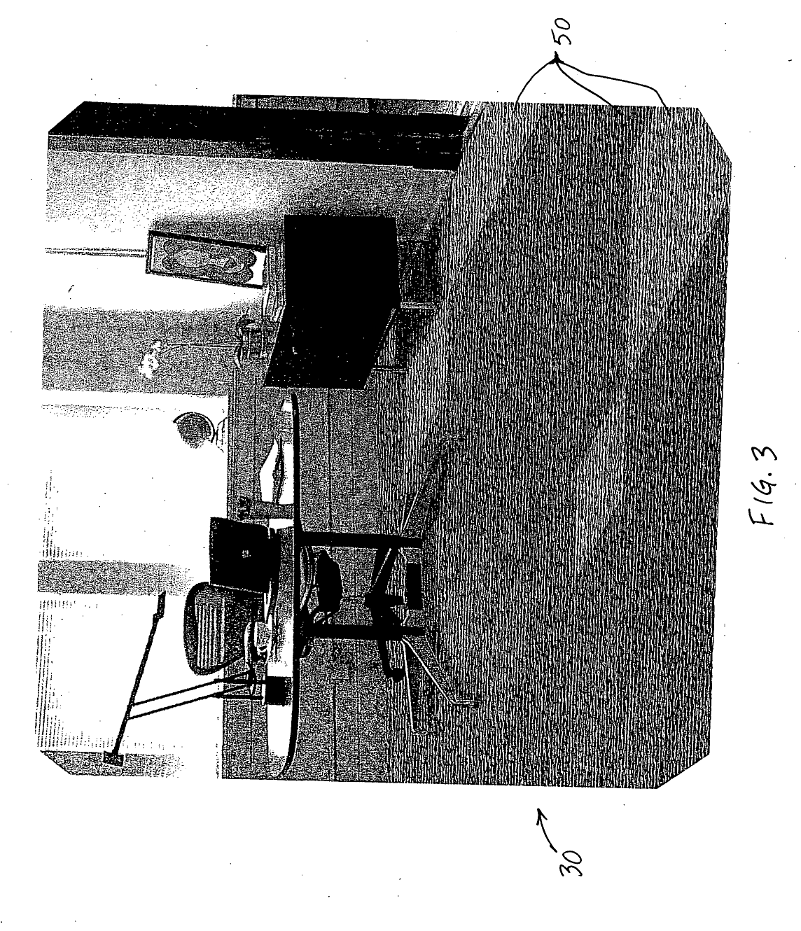

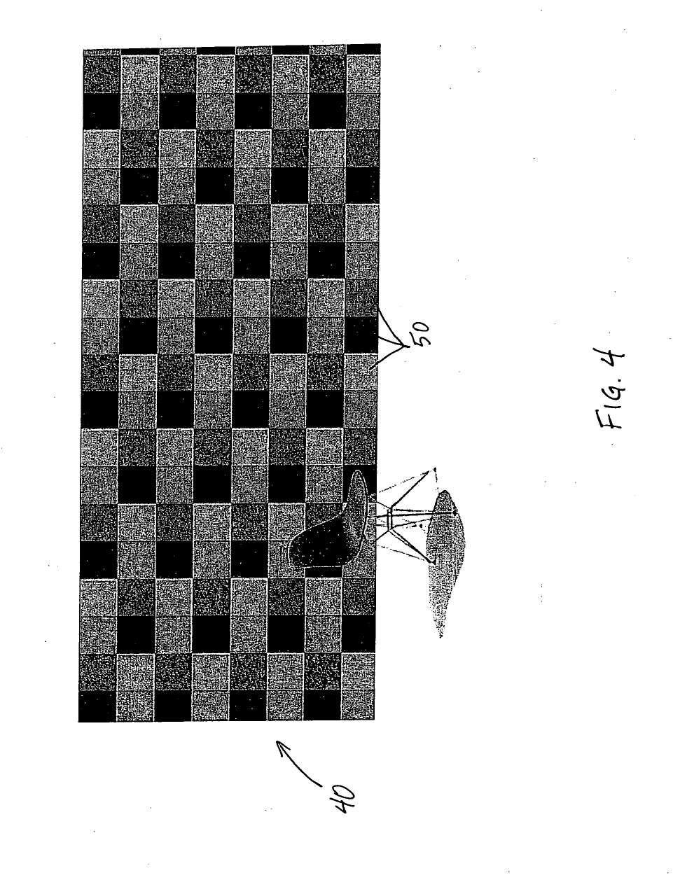

The present invention also includes a system and method of design using modular surface treatment materials. A matrix having a plurality of different colors and a plurality of different tonal intensities within each color is preferably defined, substantially as described above. Units of modular surface treatment material such as for example, carpet tiles, floor tiles, ceiling tiles, wall-covering sheets, wall panels, or other modular material units are preferably provided in each of the plurality of different colors and tonal intensities. One or more of the modular surface treatment material units are then preferably specified for application to define a surface having a desired pattern or design. The design method of the present invention optionally further comprises the application of modular surface treatment material units as specified to cover or form a surface. Alternatively, the method comprises design only, for separate installation and application by another party, or for review and approval prior to installation. FIGS. 3 and 4 depict floor and wall surfaces, 30 and 40 respectively, designed according to example embodiments of the present invention, each comprising a plurality of modular surface treatment material units 50.

In another embodiment, the present invention is a computer-implemented design system 60, described with reference to the example of FIG. 5. A computer such as a PC, or a network of two or more computers linked by a communication system such as the Internet or a private intranet, is preferably programmed with software to allow a designer or a design team to implement the design methods described herein. The size and shape of a surface to be decorated or otherwise treated using modular surface treatment materials is preferably specified, for example by inputting dimensions and/or other data regarding the floor-plan or other surface layout of one or more rooms using a keyboard, a mouse, or other input device. A display device, such as a CRT or LCD display screen displays a scaled depiction of the surface to be treated.

The depicted surface is preferably sectioned into a grid 66 of elements corresponding to the scaled size of a unit of the modular surface treatment material to be applied. The grid may be automatically applied, so as to center a pattern onto the surface, to minimize the amount of cutting of units of treatment material required, and/or to accomplish other specified objectives; or may be manually applied by the designer. The size of the grid elements may be specified by the user, selected from two or more standard sizes, and/or may be defined by the system as a default size.

The computer is preferably programmed to generate a graphical user interface 62 on the display device, allowing the designer to select from a displayed palette 64 corresponding to the above-described matrix of colors and tonal variations, and to apply units of selected color and tonal variation to selected sections of the grid. For example, a mouse-actuated click-and-drag format may be provided to allow the designer to click on a portion of the palette corresponding to a desired color and tonal variation, and drag the computer's mouse pointer to a selected element of the grid, whereupon that element of the grid is displayed in the selected color and tonal variation. The designer applies a selected color and tone to each section of the grid to complete a design or pattern, and the pattern is displayed on the computer display as a scale model of the pattern that may be applied to the floor or other surface to be decorated or otherwise treated. The design or pattern is storable in computer memory and/or on portable memory such as a floppy-disk, CD, memory stick, or the like.

In further preferred embodiments, the computer-implemented design system includes an output device such as a color printer or plotter, for generating output showing the design in hardcopy, for example to show a client or prospective client, or to use in installation of the modular surface treatment materials. The computer-implemented design system optionally also generates output including a count of the quantity and type (e.g., by color, tone and size; by SKU; or by other identification means) of the modular surface treatment materials to be used in the design, for ordering supplies, estimating costs, etc. The computer-implemented design system optionally also generates step-by-step installation instructions, for example in written or graphic format, for use by an installer of the modular surface treatment materials.

Other embodiments of the present invention include the software for implementing the above described system and method on a general purpose or special purpose computer or computer network, and elements of computer readable media, such as a floppy disk, a CD, a memory card, a chip or the like, comprising that software.

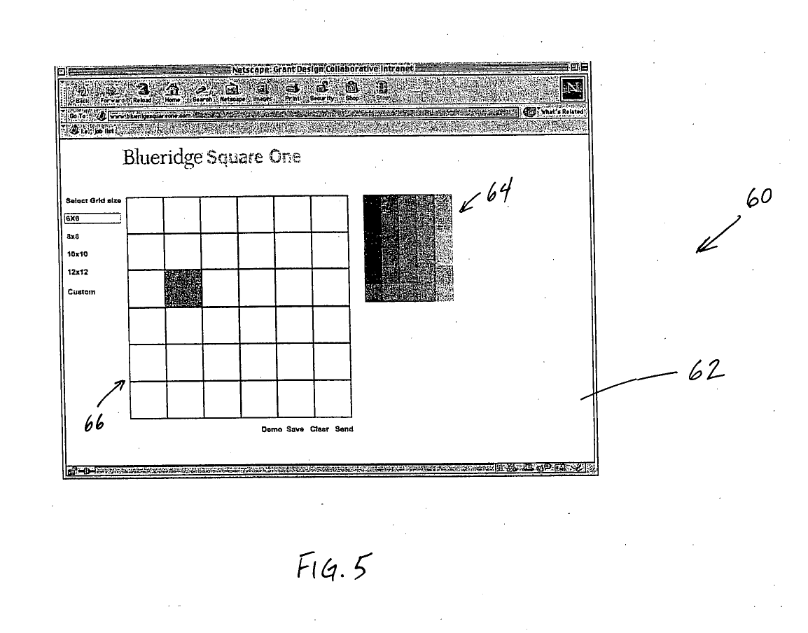

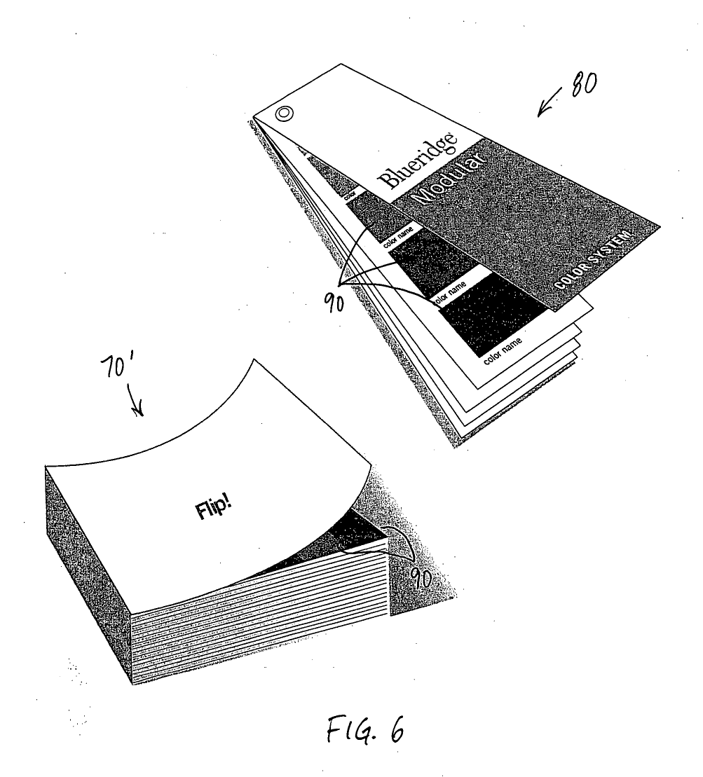

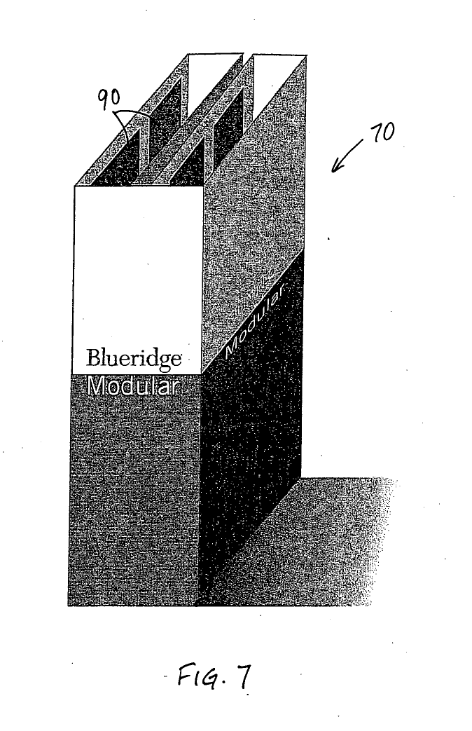

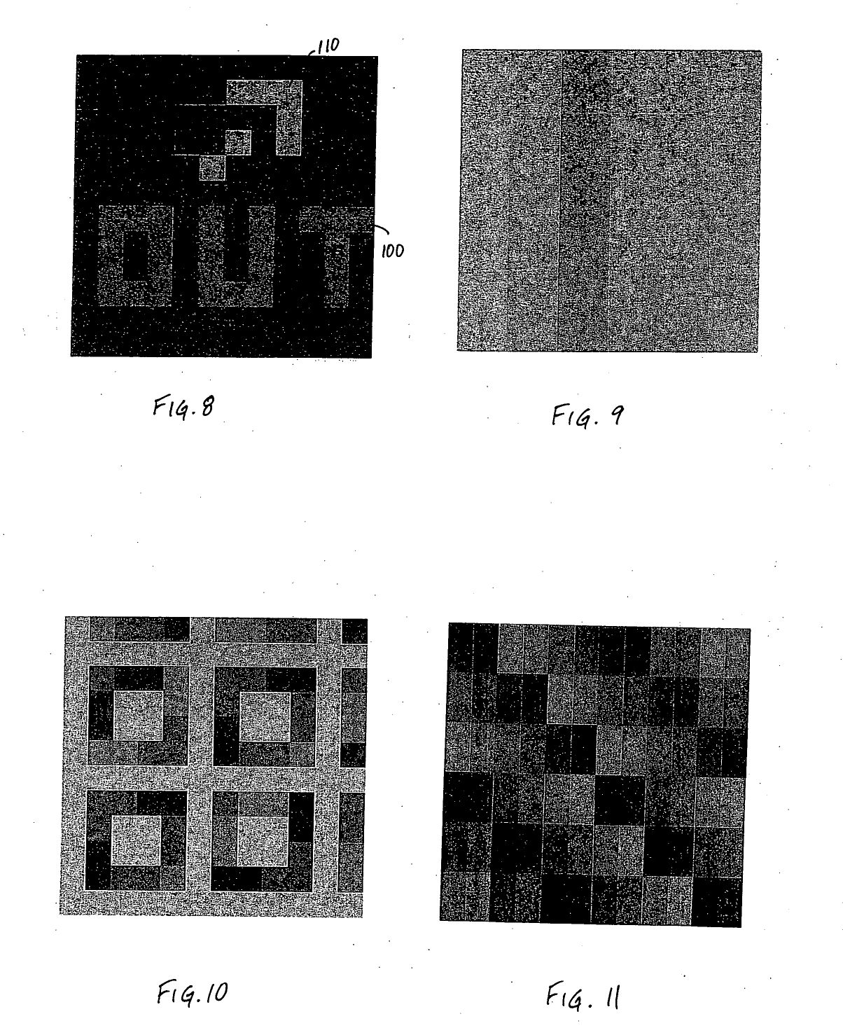

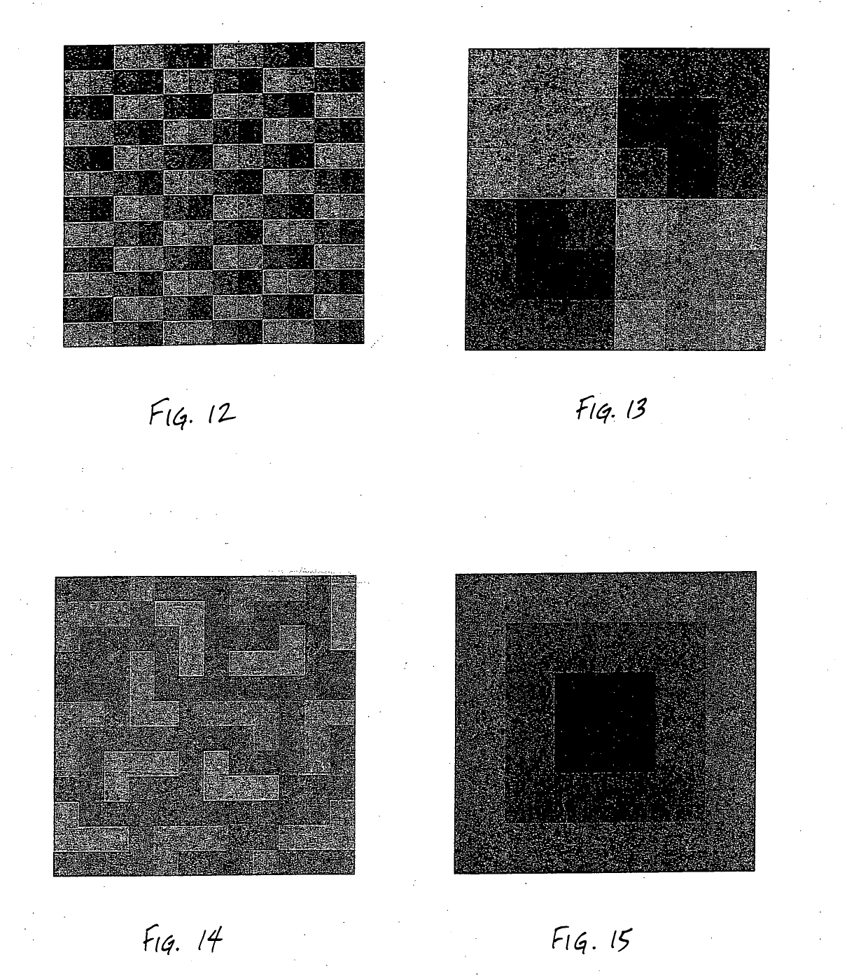

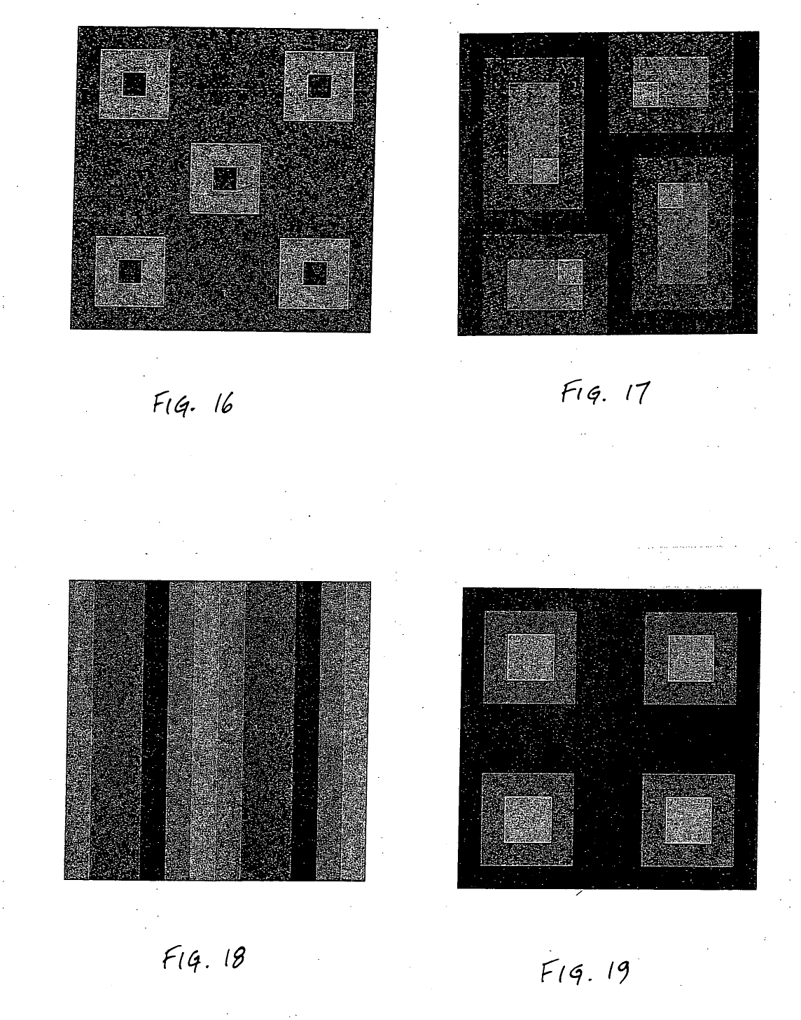

The present invention also includes display devices, such as a sample book 70 (FIGS. 6 and 7), or one or more sample cards 80 (FIG. 6) including depictions or actual samples 90 of modular surface treatment materials and/or a color-tone matrix as described herein. The present invention also includes a surface treated according to any embodiment of the system and/or method described herein, as well as a unit of modular surface treatment material as described herein. FIGS. 8-19 depict example surfaces designed according to various embodiments of the system and method of the present invention. Designs according to the present invention can include, for example, the incorporation of text 100 and indicators 110, as shown in FIG. 8, and/or geometric and other decorative and functional designs.

While the invention has been described with reference to preferred and example embodiments, it will be understood by those skilled in the art that a variety of modifications, additions and deletions are within the scope of the invention, as defined by the following claims.

1-18. (canceled)

19. A computer assisted design system comprising:
a computer having a display device and at least one input device for receiving input from a designer;
a graphical user interface facilitating input via the at least one input device of data representing a decorated surface and modular surface treatment units selected for application to the decorated surface, wherein the selected modular surface treatment units comprise a plurality of different colors and a plurality of different tonal intensities within each different color.

20. The computer assisted design system of claim 19, wherein the graphical user interface generates a design for display on the display device showing a representation of the selected modular surface treatment units applied to form the decorated surface.

21. The computer assisted design system of claim 19, further comprising an output device for generating hardcopy output.

22. The computer assisted design system of claim 19, further comprising software for generating a materials list.

23. The computer assisted design system of claim 19, further comprising software for generating installation instructions.

24. A computer assisted design system comprising:
a computer having a display and at least one input device for receiving input from a designer; and
software operable on said computer for allowing the designer to select at least one representation of a modular surface treatment unit from a matrix of represented modular surface treatment materials using the at least one input device, and apply the selected at least one representation of a modular surface treatment unit to a representation of a surface shown on the display;
wherein said matrix of represented modular surface treatment materials comprises:
representations of modular surface treatment units having a first color and a sequential array of tonal variations within said first color, and
representations of modular surface treatment units having a second color different from the first color, and a sequential array of tonal variations within said second color.

25. The computer assisted design system of claim 24, further comprising at least one output device for generating hardcopy output.

26. The computer assisted design system of claim 24, further comprising software operable on said computer for generating a materials list.

27. The computer assisted design system of claim 24, further comprising software operable on said computer for generating material installation instructions.

28. The computer assisted design system of claim 24, wherein the matrix of represented modular surface treatment materials comprises representations of modular surface treatment units in at least three different colors.

29. The computer assisted design system of claim 28, wherein the matrix of represented modular surface treatment materials comprises representations of modular surface treatment units in at least three different tonal variations of each of said at least three different colors.

30. The computer assisted design system of claim 24, wherein each sequential array of tonal variations within the matrix of represented modular surface treatment materials comprises a regular sequence.

31. The computer assisted design system of claim 30, wherein each regular sequence comprises a series of elements with each successive element having a tonal intensity of about one-half that of an immediately preceding element.

32. The computer-assisted design system of claim 30, wherein each regular sequence comprises a series of elements with each successive element having a tonal intensity of about twenty percent less than that of an immediately preceding element.

33. A storage medium having computer-implementable software residing thereon, said software enabling a designer to select and apply units from a matrix of colors and tonal variations to selected portions of a computer-simulated object.

34. The storage medium of claim 33, wherein the matrix of colors and tonal variations comprises at least three colors, and an array of at least three tonal variations within each of said at least three colors.

35. The storage medium of claim 34, wherein the tonal variations within each array comprise a regular sequence tonal intensities.

36. The storage medium of claim 33, wherein the computer-simulated object is a representation of a floor surface, and wherein the units selected and applied thereto are representations of modular floor-covering material units.

37. The storage medium of claim 33, wherein the computer-simulated object is a representation of a wall surface, and wherein the units selected and applied thereto are representations of modular wall-covering material units.

38. The storage medium of claim 33, wherein said software further enables generation of a materials list.

39. The storage medium of claim 33, wherein said software further enables generation of material installation instructions.
